(19) United States
(12) Patent Application Publication
(10) Pub. No.: US 2010/0214460 A1
(43) Pub. Date: Aug. 26, 2010

(54) SOLID-STATE IMAGING DEVICE

(75) Inventors: Hikaru HASEGAWA, Osaka (JP); Yasuyuki ENDOH, Hyogo (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/691,132

(22) Filed: Jan. 21, 2010

(30) Foreign Application Priority Data
Feb. 25, 2009 (JP) 2009-043035

(51) Int. Cl. H04N 5/335

(52) U.S. Cl. 348/300; 348/E05.091

(57) ABSTRACT

A solid-state imaging device according to the present invention includes two-dimensionally arranged unit cells each of which includes a photodiode, a transfer transistor, a floating diffusion, a reset transistor having a source and a drain one of which is connected to the floating diffusion, an amplification transistor, and a selecting transistor, a drain line which is connected to the other one of the source and the drain of the reset transistor and a drain of the amplifying transistor, and a potential switching circuit which is connected to the drain line and sets potential of the floating diffusion to a potential equal to or lower than reset potential by setting potential of the drain line.

### BACKGROUND OF THE INVENTION

(1) Field of the Invention

The present invention relates to solid-state imaging devices.

(2) Description of the Related Art

In recent years, various manufacturers are actively developing MOS-type solid-state imaging devices among solid-state imaging devices. MOS-type solid-state imaging devices have a structure in which, in each unit cell, a signal generated in a photoelectric conversion unit is amplified using a MOS transistor and then taken out.

FIG. 10 shows a structure of a conventional solid-state imaging device shown in Patent Reference 1, that is, a MOS-type solid-state imaging device.

A MOS-type solid-state imaging device 1001 includes a sensor unit 1003 in which unit cells 1002 are arranged in rows and columns, a column scanning circuit 1004 and a row scanning circuit 1005 which drive the sensor unit 1003, a correlated double sampling (CDS)/signal holding circuit 1006 which receives a signal from a row of the unit cells 1002 in the sensor unit 1003, and an output amplifier 1007.

Each of the unit cells 1002 includes a photodiode PD which performs photoelectric conversion, a transfer transistor (MOS transistor) QT which transfers a signal charge from the photodiode PD to a detecting unit (floating diffusion) N, an amplifying transistor (MOS transistor) QA which outputs a signal voltage depending on a potential of the detecting unit N to a column signal line 1008, an address transistor (MOS transistor) QD which selects from the rows of the unit cells 1002, and a reset transistor (MOS transistor) QR which resets a potential of the detecting unit N.

A cathode of the photodiode PD is connected to one of main electrodes (one of a source electrode and a drain electrode) of the transfer transistor QT, and an anode of the photodiode PD is grounded. The other one of the main electrodes (the other one of the source electrode and the drain electrode) of the transfer transistor QT is connected to a gate electrode of the amplifying transistor QA and to one of main electrodes (one of a source electrode and a drain electrode) of the reset transistor QR. A gate electrode of the transfer transistor QT is connected to a column readout line 1011 which runs from the column scanning line 1004. One of main electrodes (one of a source electrode and a drain electrode) of the amplifying transistor QA is connected to a power voltage Vdd, and the other one of the main electrodes (the other one of the source electrode and the drain electrode) is connected to the column signal line 1008 via the address transistor QD. A gate electrode of the address transistor QD is connected to a column selecting line 1012 which runs from the column scanning circuit 1004. The other one of the main electrodes (the other one of the source electrode and the drain electrode) of the reset transistor QR is connected to a power voltage Vdd, and a gate electrode of the reset transistor QR is connected to a reset line 1013 which runs from the column scanning circuit 1004. A buffer circuit 1015 is connected to the column selecting line 1012, a buffer circuit 1016 to the reset line 1013, and a buffer circuit 1031 to the column readout line 1011. A negative voltage generating circuit 1021 is connected to the buffer circuit 1031.

One end of the column signal line 1008 is connected to a load transistor QL, and the other end is connected to a transistor QS. The transistor QS is connected to the CDS/signal holding circuit 1006. The CDS/signal holding circuit 1006 provides a signal voltage for the row signal line 1009 via a row selecting transistor QH.
(Patent Reference 1) Japanese Unexamined Patent Application Publication No. 2002-217397

### SUMMARY OF THE INVENTION

For such conventional MOS-type solid-state imaging devices, reduction of circuitry may cause decrease in breakdown voltage. Furthermore, in the case where increasing voltage and decreasing voltage are used as voltage applied to transistors included in a unit cell in order to maintain properties of the unit cells, there is a problem of deterioration in reliability of breakdown voltage of gates because of a large potential difference between terminals of each of the transistors.

Specifically, in a conventional MOS-type solid-state imaging device described in Patent Reference 1, first a potential of a floating diffusion is raised to a reset potential by putting a reset transistor in on state with a gate electrode of a transfer transistor to which a negative voltage is applied, and then a signal charge is accumulated in the floating diffusion. Accordingly, a potential difference between a gate and a source of the transfer transistor is large in a period when a negative voltage is applied to the gate electrode of the transfer transistor and thus the transfer transistor is in off state.

Thus the present invention, conceived to address this problem, has an object of providing a solid-state imaging device with high reliability.

In order to achieve the object, the solid-state imaging device according to the present invention includes: unit cells arranged in rows and columns, each of the unit cells including: a photodiode which performs photoelectric conversion on incident light; a transfer transistor which transfers a signal charge generated in the photodiode; a floating diffusion which accumulates the signal charge transferred by the transfer transistor; a reset transistor which sets a potential of the floating diffusion to a reset potential, the reset transistor having a source and a drain one of which being connected to the floating diffusion; an amplifying transistor which outputs a signal voltage depending on the potential of the floating diffusion; and a selecting transistor which outputs the signal voltage outputted from the amplifying transistor; a drain line which is connected to the other one of the source and the drain of the reset transistor and to a drain of the amplifying transistor; and a potential switching circuit connected to the drain line and configured to set the potential of the floating diffusion to a potential equal to or lower than the reset potential by setting a potential of the drain line.

With this, the potential of the floating diffusion can be set to lower than the reset potential. Accordingly, a potential difference between terminals, such as a gate and a source, of each of the transfer transistor and a reset transistor are decreased; thus achieving a MOS-type solid-state imaging device with high reliability.

Here, the potential switching circuit is preferably a circuit inserted between the drain line and a power line and is configured to provide, as the reset potential, power voltage provided by the power voltage.

With this, a MOS-type solid-state imaging device with high reliability is achieved with a simple structure. A solid-state image according to the present invention may include: unit cells arranged in rows and columns, each of the unit cells including: a photodiode which performs photoelectric conversion on incident light; a transfer transistor which transfers a signal charge generated in the photodiode; a floating diffusion which accumulates the signal charge transferred by the transfer transistor; a reset transistor which sets a potential of the floating diffusion to a reset potential; an amplifying transistor which outputs signal voltage depending on the potential of the floating diffusion; and a selecting transistor which outputs the signal voltage outputted from the amplifying transistor; a column signal line which is provided for each of the rows of the unit cells, and transmits, in a column direction, the signal voltage outputted from the selecting transistor; and a potential switching circuit connected to the column signal line and configured to set the potential of the floating diffusion to a potential lower than the reset potential via coupling of parasitic capacitance between a source and a gate of the amplification transistor by setting potential of the column signal line.

With this, a MOS-type solid-state imaging device with high reliability is achieved.

The potential switching circuit is preferably configured to set the potential of the floating diffusion to a potential lower than the reset potential after signal voltage is outputted from the unit cell or after a shutter operation is performed.

With this, application of a large potential difference between terminals of each of the transfer transistor and the reset transistor is avoided for most period of time; thus achieving a MOS-type solid-state imaging device with higher reliability.

According to the present invention, even in the case where voltage applied to gate electrodes of a transfer transistor and a reset transistor included in a unit cell is a negative voltage, a potential difference between terminals of each of the transfer transistor and the reset transistor is decreased. Accordingly, a MOS-type solid-state imaging device with high reliability is provided.

### FURTHER INFORMATION ABOUT TECHNICAL BACKGROUND TO THIS APPLICATION

The disclosure of Japanese Patent Application No. 2009-043035 filed on Feb. 25, 2009 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram which shows a schematic structure of a MOS-type solid-state imaging device according to a first embodiment of the present invention;

FIG. 2 is an enlarged diagram which shows a structure of each of the unit cells and the vicinity thereof in a MOS-type solid-state imaging device according to the first embodiment of the present invention;

FIG. 3A shows a detailed structure of the potential switching circuit in the MOS-type solid-state imaging device according to the first embodiment of the present invention;

FIG. 3B shows a driving method of the potential switching circuit;

FIG. 4 is a timing chart which illustrates a driving method of the MOS-type solid-state imaging device according to the first embodiment of the present invention;

FIG. 5 is a block diagram which shows a schematic structure of a MOS-type solid-state imaging device according to a second embodiment of the present invention;

FIG. 6 is a timing chart which illustrates a driving method of the MOS-type solid-state imaging device according to the second embodiment of the present invention;

FIG. 7 is a block diagram which shows a schematic structure of a MOS-type solid-state imaging device according to a third embodiment of the present invention;

FIG. 8 is an enlarged diagram which shows a structure of each of the unit cells and the vicinity thereof in a MOS-type solid-state imaging device according to a comparative example of the present invention;

FIG. 9A is a timing chart which illustrates a driving method of the MOS-type solid-state imaging device according to the comparative example of the present invention;

FIG. 9B is a timing chart which illustrates a driving method of the MOS-type solid-state imaging device according to the comparative example of the present invention; and

FIG. 10 shows a structure of a conventional MOS-type solid-state imaging device.

### DESCRIPTION OF THE PREFERRED EMBODIMENTS

Embodiments of the present invention are hereinafter described with reference to figures.

### First Embodiment

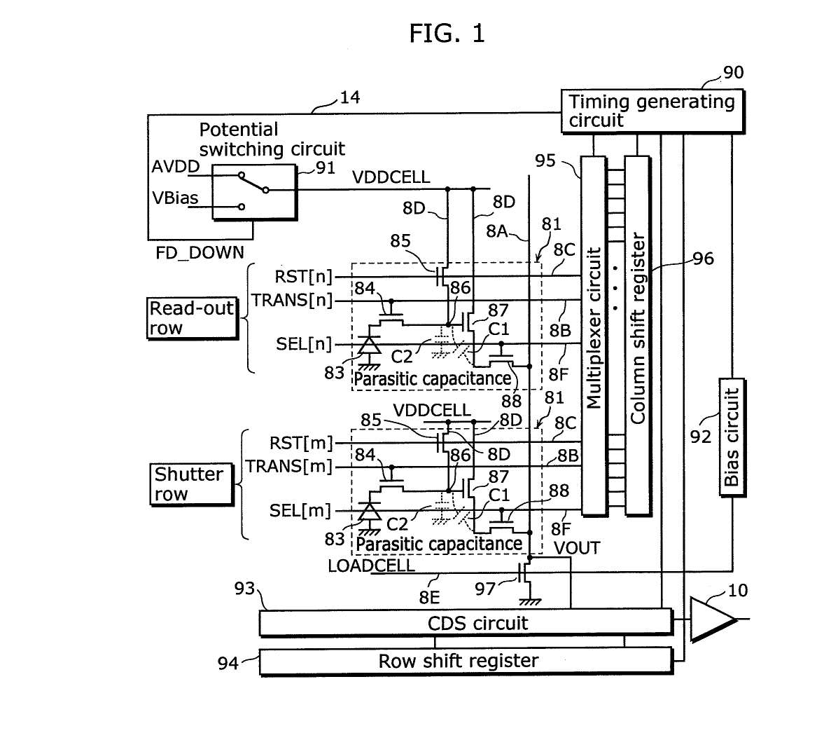

FIG. 1 is a block diagram which shows a schematic structure of a MOS-type solid-state imaging device according to a first embodiment of the present invention. Although unit cells shown in FIG. 1 are arranged in two rows and one column for simplicity, the size of the MOS-type solid-state imaging device is not limited to this.

As shown in FIG. 1, this solid-state imaging device is provided with an imaging area including unit cells 81 two-dimensionally arranged on a semiconductor substrate.

Each of the unit cells 81 includes a photodiode (PD) 83 which generates a signal charge by performing photoelectric conversion on incident light, a floating diffusion (FD) 86 which accumulates the signal charge transferred by a transfer transistor 84, the transfer transistor 84 which transfers the signal charge generated in the photodiode 83 to the floating diffusion 86, a reset transistor 85 which resets (initializes) a potential (VFD) of the floating diffusion 86 to a reset potential, an amplifying transistor 87 which outputs a signal voltage depending on the VFD, a selecting transistor 88 which selects from rows of unit cells 81 and outputs the signal voltage outputted from the amplifying transistor 87 to a column signal line 8A, the column signal line 8A which is provided for each column of the unit cells 81, routed in a vertical direction (or a column direction), and transfers the signal voltage outputted from the selecting transistor 88 in the vertical direction, and a drain line (VDDCELL) 8D which provides the reset potential for the reset transistor 85.

In more detail about the structure of each of the unit cells 81, an anode of the photodiode 83 is grounded, and a cathode of the photodiode 83 is connected to the floating diffusion 86 via the transfer transistor 84. The floating diffusion 86 is connected to one of electrodes (one of a source electrode and a drain electrode) of the reset transistor 85 which resets the floating diffusion 86 and to a gate electrode of the amplifying transistor 87.

The other one of the electrodes (the other one of the source electrode and the drain electrode) of the reset transistor 85 and a drain electrode of the amplifying transistor 87 is connected to the drain line 8D. The drain line 8D is connected to the unit cells 81 commonly and to a timing generating circuit 90 via a potential switching circuit 91. The timing generating circuit 90 generates a driving signal according to drive timing which is described later.

The potential switching circuit 91 is connected to the drain line 8D and sets the VFD to a potential equal to or lower than the reset potential by setting potential of the drain line 8D. The potential switching circuit 91 is a circuit inserted between a power line, which provides constant power AVDD, and the drain line 8D, and provides the unit cells 81 with the constant power AVDD as a reset potential. After the unit cell 81 provides signal voltage for the column signal line 8A or after a shutter operation which is described later is performed, the potential switching circuit 91 sets the VFD to a potential (VBias), which is lower than the AVDD.

A source electrode of the amplifying transistor 87 is connected to one of electrodes (one of a source electrode and a drain electrode) of the selecting transistor 88, and the other one of the electrodes (the other one of the source electrode and the drain electrode) of the selecting transistor 88 to the column signal line 8A.

A gate electrode of the transfer transistor 84 is connected to a transfer-gate line (TRANS) 8B which is routed in a row direction. A gate electrode of the reset transistor 85 is connected to a reset line (RST) 8C which is routed in the row direction. The transfer-gate line 8B and the reset line 8C are commonly connected to the unit cells 81 arranged in the same row and to a multiplexer circuit 95. A gate electrode of the selecting transistor 88 is connected to the multiplexer circuit 95 via a selecting line 8F. The multiplexer circuit 95 provides a driving signal according to drive timing which is described later. The unit cells 81 in all the rows of the solid-state imaging device shown in FIG. 1 have an identical structure.

The multiplexer circuit 95, which is an example of the driving circuit according to the present invention, sets a gate potential of the transfer transistor 84 to a negative potential in a period of time other than a period of time when a signal charge is transferred from the photodiode 83 to the floating diffusion 86. The multiplexer circuit 95 also sets the gate potential of the reset transistor 85 to a negative potential in a period of time other than a period of time when the potential of the drain line 8D is set to the potential of the floating diffusion 86.

The column signal line 8A is commonly connected to the unit cells 81 arranged in the same column. One of ends of the column signal line 8A is connected to one of electrodes (one of a source electrode and a drain electrode) of the load transistor 97. The other one of the electrodes (the other one of the source electrode and the drain electrode) of the load transistor 97 is grounded, and a gate electrode of the load transistor 97 is connected to a load gate line (LOADCELL) 8E which is routed in the row direction. The load gate line 8E is connected to the timing generating circuit 90 via a bias circuit 92.

The solid-state imaging device having the structure described above is a solid-state imaging device having the unit cells including the selecting transistor 88, and has a feature of switching potentials of the drain line 8D and providing the floating diffusion 86 with a voltage equal to or lower than power voltage via the reset transistor 85. The feature in this structure and a driving method described later solve a problem of reliability due to breakdown voltage.

In the solid-state imaging device having the structure described above, a driving signal transmitted from the timing generating circuit 90 causes a column shift register 96 to operate, and then a signal from the column shift register 96 and the driving signal from the timing generating circuit 90 are inputted into the multiplexer circuit 95. Thereby the unit cells 81 are selected on a row-by-row basis, a signal voltage of each row of the unit cells 81 is read out into the column signal line 8A, and the read signal voltage is accumulated in the CDS circuit 93 which removes a noise signal. Then the driving signal transmitted from the timing generating circuit 90 drives the row shift register 94, and the signal voltage accumulated in the CDS circuit 93 is outputted from an output amplifier 10 via the row signal line.

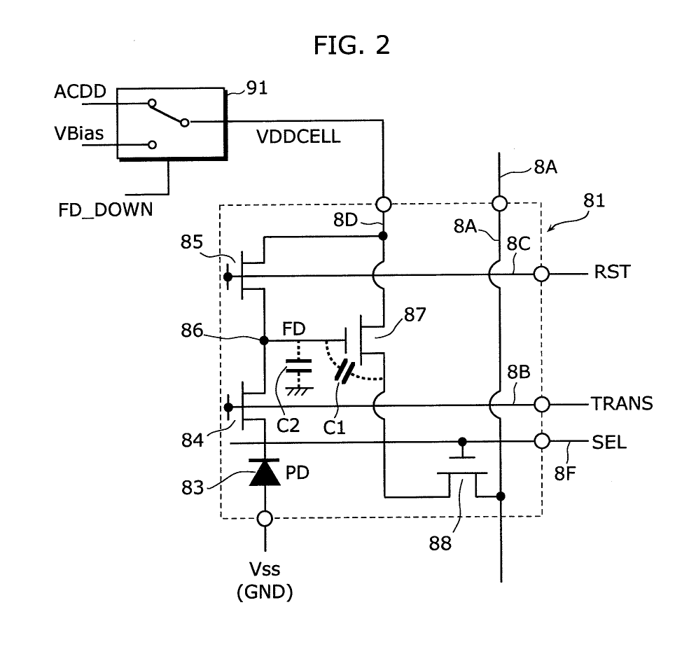

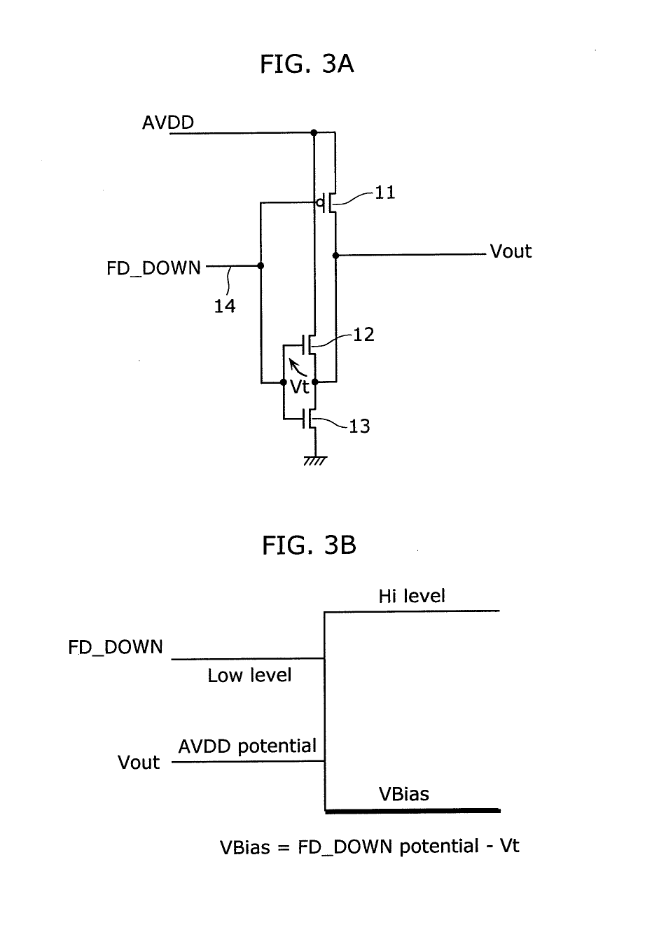

FIG. 2 is an enlarged diagram which shows a structure of each of the unit cells 81 and the vicinity thereof in the MOS-type solid-state imaging device according to the first embodiment of the present invention. FIG. 3A shows a detailed structure of the potential switching circuit 91 in the MOS-type solid-state imaging device according to the first embodiment of the present invention. FIG. 3B shows a driving method of the potential switching circuit 91.

A voltage equal to or lower than the power voltage is applied to the floating diffusion 86 for the purpose of relaxing gate-sources voltage of the transfer transistor 84 and the reset transistor 85 which are included in the unit cell 81, and thus precision is not required for the voltage to be applied. Thus the potential switching circuit 91 may be formed to have a simple structure.

The potential switching circuit, which includes a Pch MOS transistor 11, an Nch MOS transistor 12, an Nch MOS transistor 13, and an FD down line 14, switches voltages to be provided for the unit cell 81 according to a driving pulse FD_DOWN provided via the FD down line (FD_DOWN) 14.

A drain electrode of the Pch MOS transistor 11 is connected to an output line (Vout), a source electrode thereof to the constant power AVDD, and a gate electrode thereof to the FD down line 14. A drain electrode of the Nch MOS transistor 12 is connected to the constant power AVDD, a source electrode thereof to the output line, and a gate electrode to the FD down line 14. A drain electrode of the Nch MOS transistor 13 is connected to the output line, a source electrode thereof to the GND, and a gate electrode to the FD down line 14.

Application of the driving pulse FD_DOWN at a low-level from the timing generating circuit 90 to the FD down line 14 puts the Pch MOS transistor 11 in on state, and then the AVDD (for example, 3.3 V) is outputted to the output line. On the other hand, application of the driving pulse FD_DOWN at a high-level to the FD down line 14 puts the

Pch MOS transistor 11 in off state. Thereby the output line is disconnected from the constant power AVDD, and a voltage (VBias of, for example, 0.7 V) which is lower than the AVDD determined by the difference between a voltage applied to the FD down line 14 and a threshold voltage Vt of the Nch MOS transistor 12 is outputted to the output line.

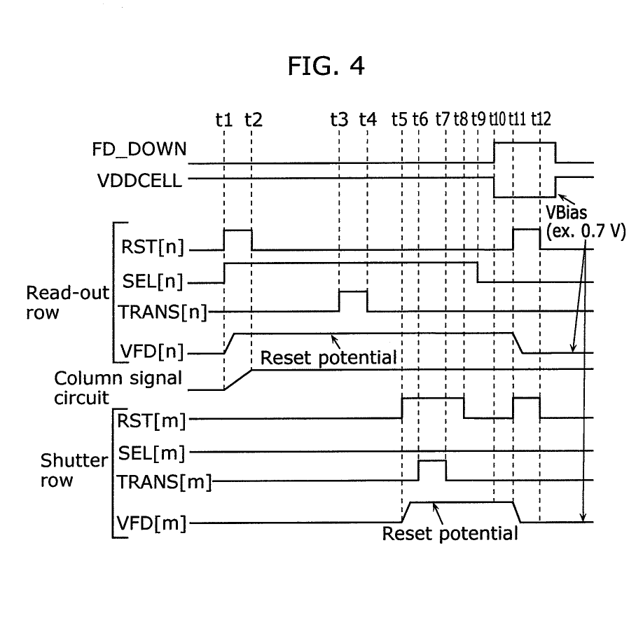

A driving method for lowering the VFD in the MOS-type solid-state imaging device according to the first embodiment of the present invention to the power potential or lower is hereinafter described. FIG. 4 is a timing chart which illustrates an operation (a driving method) of the MOS-type solid-state imaging device according to the first embodiment of the present invention.

In the unit cell 81 in a read-out row (the unit cell 81 in the nth row) from which a signal is read out (in other words, signal voltage is outputted from the unit cell 81 to the column signal line 8A), firstly a driving pulse SEL at a high level is applied to the selecting transistor 88, so that the unit cell 81 in the read-out row is put in selected state (t1). At this time, a driving pulse FD_DOWN at a low level is applied to the potential switching circuit 91, and a voltage of the constant power AVDD (for example, 3.3 V) is applied to the drain line 8D connected to the potential switching circuit 91, so that the drain line 8D is in high state. In addition, a reset pulse RST at a high level is applied to the reset transistor 85, so that the reset transistor is in on state. As a result, the VFD is set to the reset potential (AVDD) in the unit cell 81 in the read-out row.

Next, the reset pulse RST at a low level is applied to the reset transistor 85, so that the potential of the reset line 8C falls (t2).

Next, a transfer-gate pulse TRANS of a high level is applied to the transfer transistor 84, so that the transfer transistor 84 is put in on state (t3). In the case where no light enters the photodiode 83 and no signal charge (photoelectron) is accumulated there, no charge is transferred and the VFD remains equal to the reset potential because the photodiode 83 has no signal charge even when the transfer transistor 84 is turned on. In contrast, in the case where light enters the photodiode 83 and a signal charge is accumulated there, the signal charge is transferred from the photodiode 83 to the floating diffusion 86, and the VFD falls depending on the signal charge. The potential of the column signal line 8A falls to reach a potential lower than the VFD roughly by the difference of gate-source potential (Vgs) of the amplifying transistor 87. The potential (signal level) of the column signal line 8A is taken into a circuit in the next stage.

Next, the transfer-gate pulse TRANS at a low level is applied to the transfer transistor 84, so that the transfer transistor 84 is put in off state (t4).

Next, a driving pulse SEL at a low level is applied to the selecting transistor 88, so that the potential of the selecting line 8F falls and the unit cell 81 in the read-out row is put in unselected state (t9).

Next, the driving pulse FD_DOWN at a high level is applied to the FD down line 14, so that the potential switching circuit 91 outputs VBias (for example, 0.7 V). As a result, the potential of the drain line 8D falls to be equal to the VBias (t10).

Next, the reset pulse RST at a high level is applied to the reset transistor 85, so that the potential of the reset line 8C rises. As a result, the reset transistor 85 is put in on state, and the VFD falls to be equal to the VBias (t11).

Here, the gate-source voltage when the transfer transistor 84 and the reset transistor 85 are off is calculated using EQ. 1, where the gate potential is negative (for example, −1.0 V) when the transfer transistor 84 and the reset transistor 85 are off.

Vgs=VFD(=0.7 V)−Vg(=−1.0 V)=1.7 V EQ. 1

The state in which the VFD is set to low is maintained from when signals are read out at t1 to t9 until when the next shutter operation (an operation performed for the unit cells 81 in shutter rows in the period of time from t5 to t7 shown in FIG. 4) is performed or, in the case where a shutter operation is not performed, until the next signal readout is performed; thus the problem of deterioration in reliability due to breakdown voltage of the gate described above is solved.

On the other hand, in the unit cell 81 in a shutter row (the unit cell 81 in the mth row) where a shutter operation is performed, firstly a driving pulse SEL at a low level is applied to the gate electrode of the selecting transistor 88, so that the unit cell 81 in the shutter row is put in unselected state.

Next, the shutter operation is performed (t5 to t7). As the drain line 8D is provided with the constant voltage AVDD (for example, 3.3 V) from the potential switching circuit 91, the VFD is set to be equal to the AVDD.

Next, as in the unit cell 81 in the read-out row, the driving pulse FD_DOWN at a high level is applied to the FD down line 14 (t10). As a result, the potential switching circuit 91 outputs VBias, so that the potential of the drain line 8D falls to be equal to the VBias.

Next, a reset pulse RST at a high level is applied to the reset transistor 85, so that the reset transistor 85 is put in on state (t11 to t12). As a result, the VFD falls to be equal to the VBias.

At this time, as in the unit cell 81 in the read-out row, the gate-source voltage when the transfer transistor 84 and the reset transistor 85 are off is calculated using EQ. 2, where the gate potential is negative (for example, −1.0 V) when the transfer transistor 84 and the reset transistor 85 are off.

Vgs=VFD(=0.7 V)−Vg(=−1.0 V)=1.7 V EQ. 2

Accordingly, the gate-source voltage of each of the transfer transistor 84 and the reset transistor 85 falls immediately after the shutter operation, and the fallen gate-source voltages are maintained until the next signal readout is performed; thus the problem of deterioration in reliability due to breakdown voltage of the gate described above is solved.

Thus, in the MOS-type solid-state imaging device according to the first embodiment of the present invention, lowering the VFD reduces potential differences between gates and sources of the transfer transistor 84 and the resetting transistor 85, the transistors included in the unit cell 81 in which a shutter operation has been performed or a signal has been read out. Accordingly, potential differences between the gates and the sources of the transistors included in the unit cell 81 may be reduced even in the case where a voltage applied to the gate electrode of each of the transfer transistor 84 and the reset transistor 85 is negative. As a result, not only the problem of reliability due to breakdown voltage of the gate is solved but also a countermeasure against dark current is provided.

For example, increase in the potential difference between the gate and the source of the transfer transistor 84 is prevented in a period of time after the VFD is raised to be equal to the reset potential when the transfer transistor 84 is put in off state by applying a negative voltage to the gate electrode of the transfer transistor 84 and the reset transistor 85 is put in on state. The state in which the VFD is set to low is maintained in the unit cell 81 in the read-out row until a shutter operation is performed or, when the shutter operation is not used, until the next signal readout is performed. On the other hand, this state is maintained in the unit cell 81 in the shutter row until a signal read out is performed. Accordingly, a situation where a high potential difference is applied between the gate and the source of the transfer transistor 84 is avoided for most period of time; thus the problem of deterioration in reliability due to breakdown voltage of the gate described above is solved.

Furthermore, in the MOS-type solid-state imaging device according to the first embodiment, each of the unit cells 81 has a structure of four transistors including the selecting transistor 88. Accordingly, high precision is not required for a potential to which the VFD is lowered; thus a bias circuit may be simplified.

### Second Embodiment

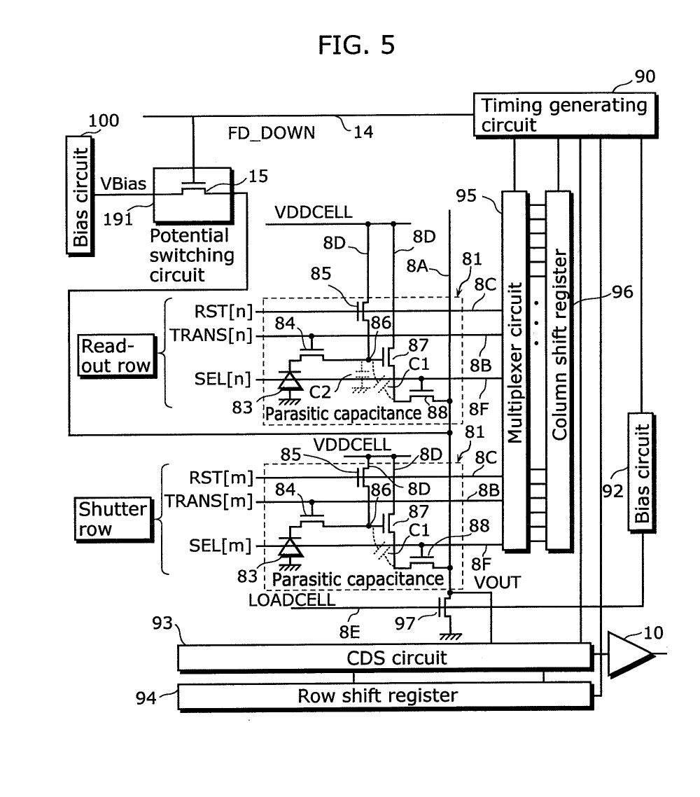

FIG. 5 is a block diagram which shows a schematic structure of a MOS-type solid-state imaging device according to a second embodiment of the present invention. Although unit cells shown in FIG. 5 are arranged in two rows and one column for simplicity, the size of the MOS-type solid-state imaging device is not limited to this.

In comparison with the solid-state imaging device according to the first embodiment shown in FIG. 1, this solid-state imaging device is different in that it has a structure in which a bias circuit 100 is connected to the column signal line 8A via a potential switching circuit 191. This feature in the structure allows lowering VFD.

A constant voltage VBias (for example, 0.7 V) is outputted from the bias circuit 100. As described above, a voltage applied when lowering the VFD needs not take a precise value. Accordingly, a unit for switching potentials of the VFD may be provided with a simple structure. Illustrated in FIG. 5 is such a simple structure of the bias circuit 100 and the potential switching circuit 191 which lower the VFD

The potential switching circuit 191 includes an Nch MOS transistor 15. The potential switching circuit 191 is connected to the column signal line 8A, and sets potential of the column signal line 8A via a driving pulse FD_DOWN which is provided through an FD down line 14. The VFD is thereby lowered to be equal to reset potential (AVDD) via coupling of parasitic capacitance C1 between a source and a gate of the amplifying transistor 87.

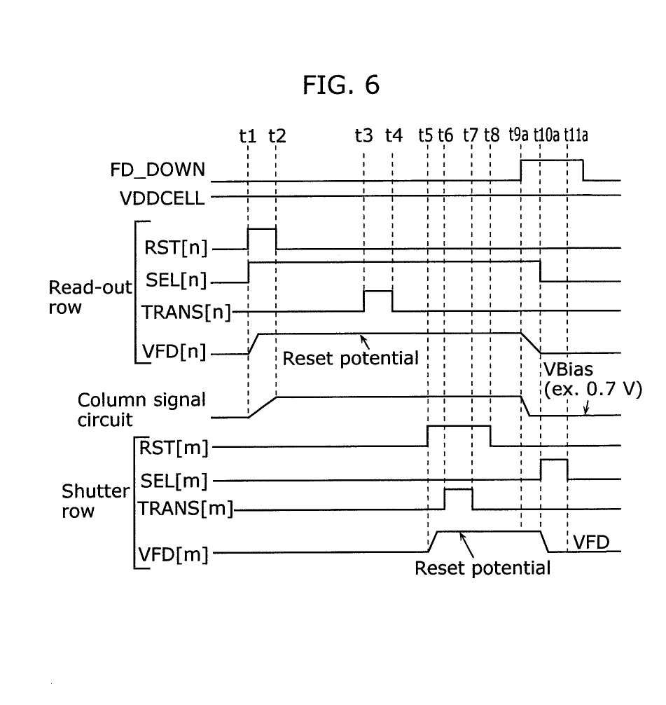

A driving method for lowering the VFD in the MOS-type solid-state imaging device according to the second embodiment of the present invention to a potential equal to or lower than the power potential is hereinafter described. FIG. 6 is a timing chart which illustrates an operation (a driving method) of the MOS-type solid-state imaging device according to the second embodiment of the present invention.

A unit cell 81 in a read-out row (a unit cell 81 in the nth row) and a unit cell 81 in a shutter row (a unit cell 81 in the mth row) are driven up to t8 in the same manner as in the first embodiment. At this time, a driving pulse FD_DOWN at a low level is applied to the FD down line 14, so that the bias circuit 100 is disconnected from the column signal line 8A.

Next, the driving pulse FD_DOWN at a high level is applied to the FD down line 14 (t9a). As a result, the Nch MOS transistor 15 is turned on, and the potential switching circuit 191 provides the column signal line 8A with VBias, so that potential of the column signal line 8A falls to the VBias (t10a). At this time, in the unit cell 81 in the read-out row, the selecting transistor 88 is in on state, so that the VFD is determined by the VBias, parasitic capacitance C1 of the amplifying transistor 87 (for example, 1.44 fF), and parasitic capacitance C2 (for example, 1.85 fF) due to an coupling effect of the parasitic capacitance C1 of the amplifying transistor 87, and falls to a value calculated using EQ. 3, where the reset potential is AVDD.

VFD=AVDD−(AVDD−VBias)·C1/(C1+C2)=1.85 V EQ. 3

Thus, in the unit cell 81 in the read-out row, the gate-source voltage when the transfer transistor 84 and the reset transistor 85 are off is calculated using EQ. 4, where the gate potential is negative (for example, −1.0 V) when the transfer transistor 84 and the reset transistor 85 are off.

Vgs=VFD(=1.85 V)−Vg(=−1.0 V)=2.85 V EQ. 4

The state in which the gate-source voltage is set to low is maintained from when signals are read out until when the next shutter operation is performed or, in the case where the shutter operation is not performed, until the next signal readout is performed; thus the problem of deterioration in reliability due to breakdown voltage of the gate described above is solved.

Next, in the unit cell 81 in the read-out row, a driving pulse SEL at a low level is applied to the selecting line 8F, so that the selecting transistor 88 is put in off state and the unit cell 81 in the read-out row is put in unselected state (t10a).

On the other hand, in the unit cell 81 in the shutter line, a driving pulse SEL at a high level is applied to the selecting line 8F immediately after the unit cell 81 in the read-out row is put in unselected state, so that the selecting transistor 88 is put in on state and the unit cell 81 in the shutter row is put in selected state (t10a to t11a). At this time, the column signal line 8A has fallen to be equal to the VBias, so that the VFD falls to a value calculated using EQ. 5 due to a coupling effect of parasitic capacitance C1 of the amplifying transistor 87.

VFD=AVDD−(AVDD−VBias)·C1/(C1+C2)=1.85 V EQ. 5

Thus, as described for the unit cell 81 in the read-out row, the gate-source voltage when the transfer transistor 84 and the reset transistor 85 are off is calculated using EQ. 4, where the gate potential is negative (for example, −1.0 V) when the transfer transistor 84 and the reset transistor 85 are off.

Accordingly, the gate-source voltage of each of the transfer transistor 84 and the reset transistor 85 falls immediately after the shutter operation, and the fallen gate-source voltage is maintained until the next signal readout is performed; thus the problem of deterioration in reliability due to breakdown voltage of the gate described above is solved.

Thus, in the MOS-type solid-state imaging device according to the second embodiment of the present invention, lowering the VFD reduces potential differences between gates and sources of transistors, that is, the transfer transistor 84 and the resetting transistor 85, included in the unit cell 81 in which a shutter operation has been performed or a signal has been read out. Accordingly, potential differences between the gates and the sources of the transistors included in the unit cell 81 may be reduced even in the case where a voltage applied to the gate electrode of each of the transfer transistor 84 and the reset transistor 85 is negative. As a result, not only the problem of reliability due to breakdown voltage of the gate is solved but also a countermeasure against dark current is provided.

For example, increase in the potential difference between the gate and the source of the transfer transistor 84 is prevented in a period of time after the VFD is raised to be equal to the reset potential when the transfer transistor 84 is put in off state by applying a negative voltage to the gate electrode of the transfer transistor 84 and the reset transistor 85 is put in on state. The state in which the VFD is set to low is maintained in the unit cell 81 in the read-out row until a shutter operation is performed or, when the shutter operation is not used, until the next signal readout is performed. On the other hand, this state is maintained in the unit cell 81 in the shutter row until a signal read out is performed. Accordingly, a situation where a high potential difference is applied between the gate and the source of the transfer transistor 84 is avoided for most period of time; thus the problem of deterioration in reliability due to breakdown voltage of the gate described above is solved.

Furthermore, in the MOS-type solid-state imaging device according to the first embodiment, each of the unit cells 81 has a structure of four transistors including the selecting transistor 88. Accordingly, high precision is not required for a potential to which the VFD is lowered; thus a bias circuit may be simplified.

### Third Embodiment

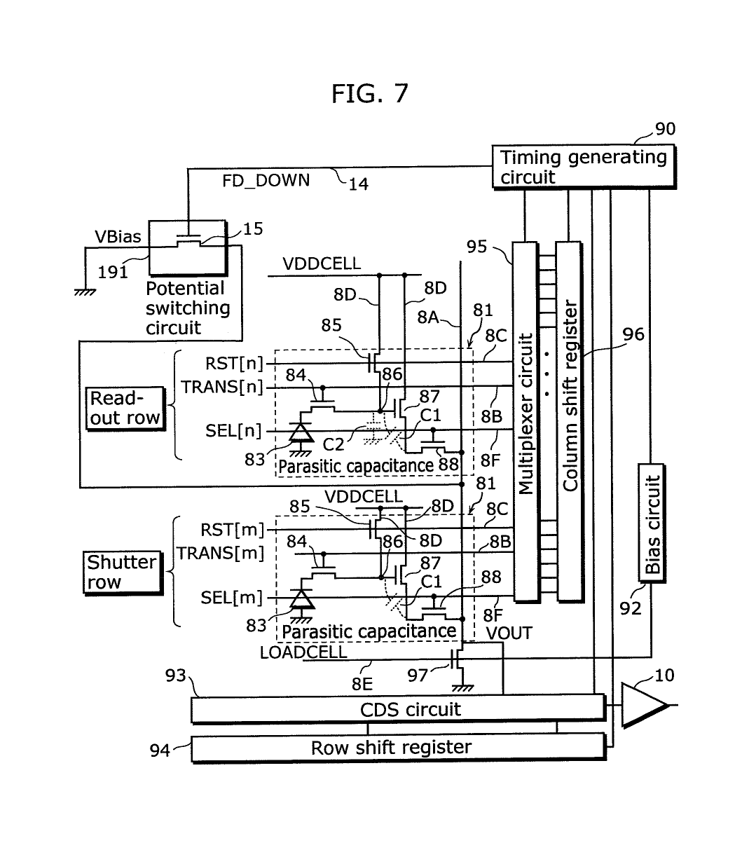

FIG. 7 is a block diagram which shows a schematic structure of a MOS-type solid-state imaging device according to a third embodiment. Although unit cells shown in FIG. 7 are arranged in two rows and one column for simplicity, the size of the MOS-type solid-state imaging device is not limited to this.

In comparison with the solid-state imaging device according to the second embodiment shown in FIG. 5, this solid-state imaging device is different in that it has a structure in which GND is connected to the column signal line 8A via the potential switching circuit 191. This feature in the structure allows lowering VFD. In comparison with the solid-state imaging device according to the second embodiment, the solid-state imaging device according to the third embodiment may have a circuit of a reduced scale because the bias circuit 100 is not necessary here.

As described above, precision is not required for a voltage applied when lowering the VFD. Accordingly, a unit for switching potentials of the VFD may be provided with a simple structure. Illustrated in FIG. 7 is such a simple structure of a circuit which lowers the VFD.

A driving method for lowering the VFD in the MOS-type solid-state imaging device according to the third embodiment of the present invention to a potential equal to or lower than the power potential is hereinafter described with reference to FIG. 6.

When using the same driving method as used with the solid-state imaging device according to the second embodiment of the present invention, application of a driving pulse FD_DOWN at a high level to the FD down line 14 causes the potential switching circuit 191 to output a GND potential (for example, 0 V) because the GND is connected to the column signal line 8A via the potential switching circuit 191. Thus the potential of the column signal line 8A falls to be equal to the GND potential at t9a. At this time, the selecting transistor 88 in the unit cell 81 in the read-out row is in on state, so that, as described for the driving method according to the second embodiment, the VFD is determined by the reset potential (=AVDD potential), the GND potential (=0 V), parasitic capacitance C1 (for example, 1.44 fF), and parasitic capacitance C2 (for example, 1.85 fF) due to an coupling effect of the parasitic capacitance C1 of the amplifying transistor 87, and falls to a value calculated using EQ. 6.

VFD=AVDD−(AVDD−GND)·C1/(C1+C2)=1.46 V EQ. 6

Thus, in the unit cell 81 in the read-out row, the gate-source voltage when the transfer transistor 84 and the reset transistor 85 are off is calculated using EQ. 7, where the gate potential is negative (for example, −1.0 V) when the transfer transistor 87 and the reset transistor 85 are off.

Vgs=VFD(=1.46 V)−Vg(=−1.0 V)=2.46 V EQ. 7

The state in which the gate-source voltage is set to low is maintained from when signals are read out until when a shutter operation is performed or, in the case where a shutter operation is not performed, until the next signal readout is performed; thus the problem of deterioration in reliability due to breakdown voltage of the gate described above is solved.

On the other hand, the selecting transistor 88 in the unit cell 81 in the shutter row is put in on state at t10a. At this time, the potential of the column signal line 8A has fallen to be equal to the GND potential, so that the VFD of the unit cell 81 in the shutter row is calculated using EQ. 8 due to a coupling effect of the parasitic capacitance C1 of the amplifying transistor 87 as the VFD of the unit cell 81 in the read-out cell is.

VFD=AVDD−(AVDD−GND)·C1/(C1+C2)=1.46 V EQ. 8

Thus, in the unit cell 81 in the shutter row, the gate-source voltage when the transfer transistor 84 and the reset transistor 85 are off is calculated using EQ. 9, where the gate potential is negative when the transfer transistor 84 and the reset transistor 85 are off.

Vgs=VFD(=1.46 V)−Vg(=−1.0 V)=2.46 V EQ. 9

Accordingly, the gate-source voltage of each of the transfer transistor 84 and the reset transistor 85 falls immediately after the shutter operation, and the fallen gate-source voltages are maintained until the next signal readout is performed; thus the problem of deterioration in reliability due to breakdown voltage of the gate described above is solved.

Thus, in the MOS-type solid-state imaging device according to the third embodiment of the present invention, lowering the VFD reduces potential differences between gates and sources of the transfer transistor 84 and the resetting transistor 85, the transistors included in the unit cell 81 in which a shutter operation has been performed or a signal has been read out. Accordingly, potential differences between the gates and the sources of the transistors included in the unit cell 81 may be reduced even in the case where a voltage applied to the gate electrode of each of the transfer transistor 84 and the reset transistor 85 is negative. As a result, not only the problem of reliability due to breakdown voltage of the gate is solved but also a countermeasure against dark current is provided.

For example, increase in the potential difference between the gate and the source of the transfer transistor 84 is prevented in a period of time after the VFD is raised to be equal to the reset potential when the transfer transistor 84 is put in off state by applying a negative voltage to the gate electrode of the transfer transistor 84 and the reset transistor 85 is put in on state. The state in which the VFD is set to low is maintained in the unit cell 81 in the read-out row until a shutter operation is performed or, when the shutter operation is not used, until the next signal readout is performed. On the other hand, this state is maintained in the unit cell 81 in the shutter row until a signal read out is performed. Accordingly, a situation where a high potential difference is applied between the gate and the source of the transfer transistor 84 is avoided for most period of time; thus the problem of deterioration in reliability due to breakdown voltage of the gate described above is solved.

Furthermore, in the MOS-type solid-state imaging device according to the third embodiment, each of the unit cells 81 has a structure of four transistors including the selecting transistor 88. Accordingly, high precision is not required for a potential to which the VFD is lowered; thus a bias circuit may be simplified.

### Comparative Example

A MOS-type solid-state imaging device according to a comparative example of the present invention is described with reference to figures.

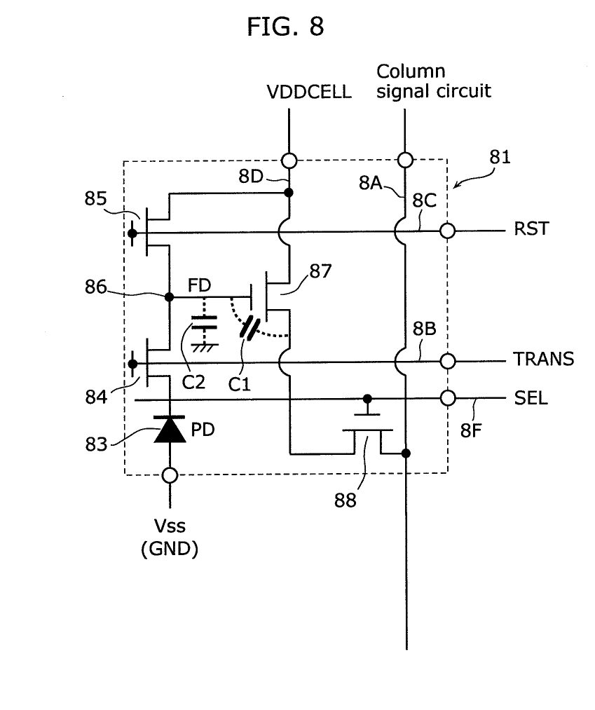

FIG. 8 is an enlarged diagram which shows a structure of each of the unit cells 81 and the vicinity thereof in a MOS-type solid-state imaging device according to the comparative example.

This solid-state imaging device is provided with an imaging area including unit cells 81 two-dimensionally arranged on a semiconductor substrate.

Each of the unit cells 81 includes a photodiode 83, a transfer transistor 84, a floating diffusion 86, a reset transistor 85, an amplifying transistor 87, and a selecting transistor 88. When the transfer transistor 84 transfers a signal charge to the floating diffusion 86, firstly the VFD is reset to a high voltage (reset voltage), and then the signal charge generated in the photodiode 83 is transferred to the floating diffusion 86. The VFD changes depending on the amount of the signal charge, and the potential change in the VFD is outputted as a pixel signal.

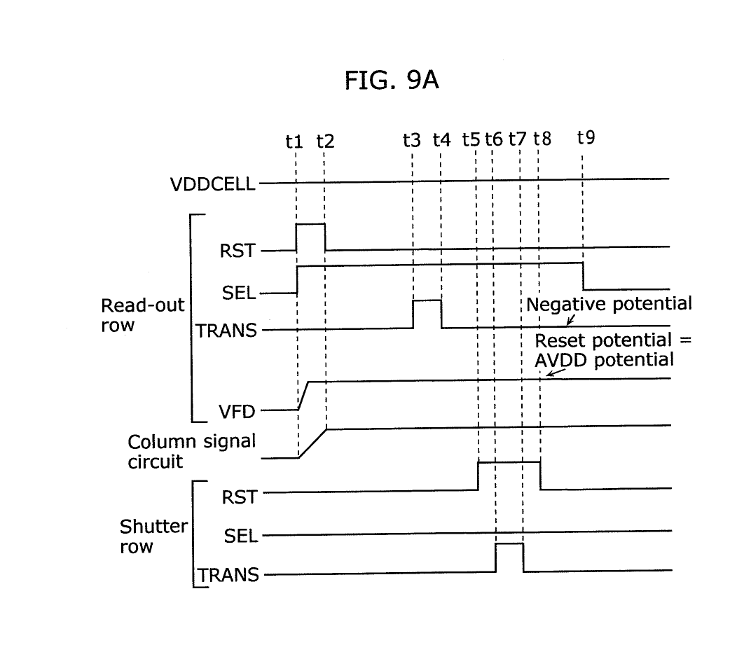

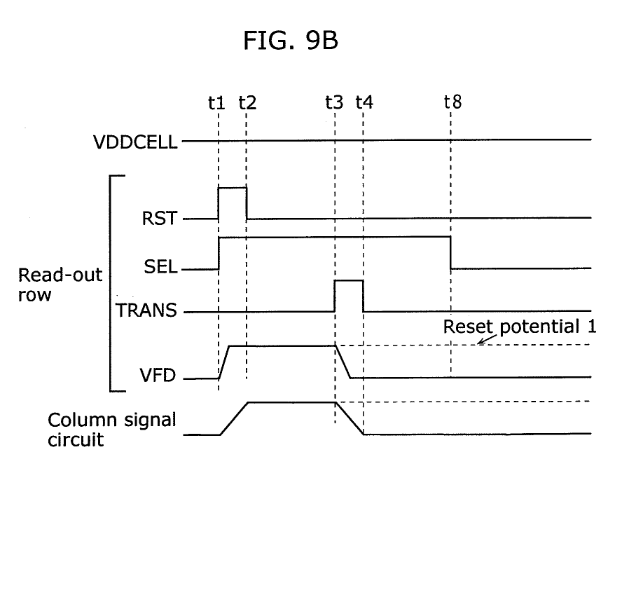

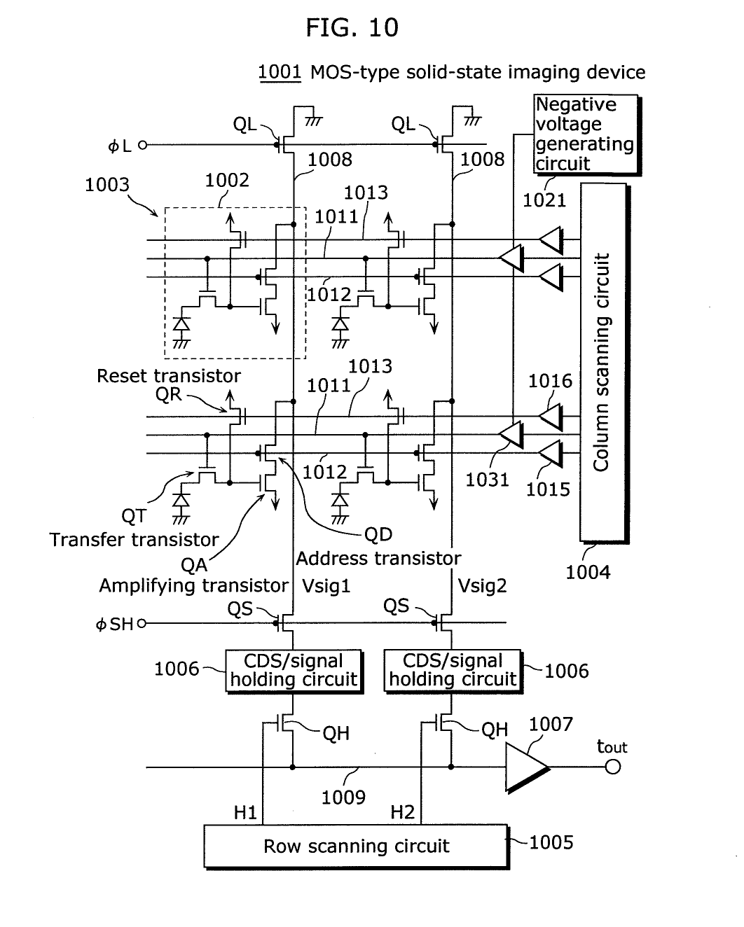

An operation of the MOS-type solid-state imaging device according to the present comparative example is hereinafter described. FIG. 9A and FIG. 9B are timing charts which illustrate an operation (a driving method) of the MOS-type solid-state imaging device according to the comparative example of the present invention. FIG. 9A is a timing chart which shows the case where no signal charge is accumulated in the photodiode 83, and FIG. 9B is a timing chart which shows the case where a signal charge is accumulated in the photodiode 83.

In the unit cell 81 in a read-out row (the unit cell 81 in the nth row), firstly a constant power AVDD is applied to a drain line 8D, and then, in a state where the potential of the drain line 8D is set to a constant potential (for example, 3.3 V), a reset pulse RST at a high level is applied to the reset transistor 85 to cause voltage in the reset line 8C to rise (t1). As a result, the reset transistor 85 is put in on state and the potential of the floating diffusion 86 becomes AVDD, which is the same as the potential of the drain line 8D. At the same time, a driving pulse SEL at high level is applied to the selecting transistor 88 to cause the potential of the selecting line 8F to rise, so that the unit cell 81 in the read-out row is put in selected state.

Next, the reset pulse RST at a low level is applied to the reset transistor 85, so that the potential of the reset line 8C falls (t2). At this time, the potential of the column signal line 8A becomes a potential (reset level) fallen from the VFD (reset potential=AVDD) by the gate-source potential-difference (Vgs) of the amplifying transistor 87. This potential of the column signal line 8A is taken into a circuit in the next stage connected to the column signal line 8A.

Next, a transfer-gate pulse TRANS at a high level is applied to the transfer transistor 84 (t3 to t4). In the case where no light enters the photodiode 83 and no signal charge (photoelectron) is accumulated there, the VFD remains equal to the reset potential (=AVDD potential) even when the transfer transistor 84 is put in on status (see FIG. 9A). In contrast, in the case where light enters the photodiode 83 and a signal charge is accumulated there, the signal charge is transferred from the photodiode 83 to the floating diffusion 86, and the potential of the floating diffusion 86 falls depending on the amount of the signal charge (see FIG. 9B). The potential of the column signal line 8A falls in conjunction with the change in the VFD to reach a potential (a signal level) lower than the VFD by the difference of gate-source potential (Vgs) of the amplifying transistor 87. The potential of the column signal line 8A is taken into a circuit in the next stage

Next, the driving pulse SEL at a low level is applied to the selecting transistor 88, so that the potential of the selecting line 8F falls and the unit cell 81 in the read-out line is put in unselected state (t9). At this time, the circuit in the next stage outputs the difference between the reset level and the signal level as a pixel signal.

On the other hand, in the unit cell 81 (the unit cell 81 in the mth row) in a shutter row, firstly a reset pulse RST at a high level is applied to the reset transistor 85 (t5).

Next, a transfer-gate pulse TRANS at a high level is applied to the transfer transistor 84 (t6). At this time, the reset transistor 85 is in on state; thus the potential of the floating diffusion 86 remains equal to the reset potential (=AVDD potential).

Next, the reset pulse RST at a low level is applied to the reset transistor 85, so that the potential of the reset line 8C falls. At this time, a driving pulse SEL remains at a low level in scanning of the unit cell 81 in the shutter row.

As described above, in the MOS-type solid-state imaging device according to the comparative example of the present invention, a gate-source potential difference of the transfer transistor 84 is large in a period of time after providing negative voltage to the gate electrode of the transfer transistor 84 sets the transfer transistor 84 to off and the reset transistor 85 to on, and the VFD is raised to the reset potential.

For example, in the case where the voltage of the drain line (VDDCELL) 8D is 3.3 V, the gate voltage when the transfer transistor 84 is set to off is −1.0 V, and especially when there is no incident light and there is no signal charge in the unit cell 81 in the read-out row as shown in FIG. 9A, the gate-source voltage of the transfer transistor 84 is a potential difference of 4.3 V which is the difference of 3.3 V and −1.0 V. This state is maintained in the unit cell 81 in a read-out row until a shutter operation is performed at t4 or later or, in the case where the shutter operation is not used, until the next signal is read out at t4 or later. On the other hand, this state is maintained in the unit cell 81 in the shutter row until the next signal is read out at t7 or later. Accordingly, a high potential difference is applied between the gate and the source of the transfer transistor 84 is for most of the period of time; thus the problem of deterioration in reliability due to breakdown voltage of the gate described above occurs.

Although only some exemplary embodiments of a solid-state imaging device according to this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

For example, each of the unit cells of the solid-state imaging device according to the embodiments described above has what is called a one-pixel-one-cell structure in which each of the unit cells has a photodiode (pixel), a transfer transistor, a floating diffusion, a reset transistor, and an amplifying transistor. However, the unit cell 81 may have a multi-pixel-one-cell structure where each of the unit cells includes a plurality of photodiodes (pixels) and the unit cells may share all or part of the floating diffusion, reset transistor, and amplifying transistor.

### INDUSTRIAL APPLICABILITY

The present invention is applicable to solid-state imaging devices, especially to MOS-type solid-state imaging devices.

What is claimed is:

1. A solid-state imaging device comprising:
unit cells arranged in rows and columns, each of said unit cells including: a photodiode which performs photoelectric conversion on incident light; a transfer transistor which transfers a signal charge generated in said photodiode; a floating diffusion which accumulates the signal charge transferred by said transfer transistor; a reset transistor which sets a potential of said floating diffusion to a reset potential, said reset transistor having a source and a drain one of which being connected to said floating diffusion; an amplifying transistor which outputs a signal voltage depending on the potential of said floating diffusion; and a selecting transistor which outputs the signal voltage outputted from said amplifying transistor;
a drain line which is connected to the other one of the source and the drain of said reset transistor and to a drain of said amplifying transistor; and
a potential switching circuit connected to said drain line and configured to set the potential of said floating diffusion to a potential equal to or lower than the reset potential by setting a potential of said drain line.

2. The solid-state imaging device according to claim 1,
wherein said potential switching circuit is a circuit inserted between said drain line and a power line and is configured to provide, as the reset potential, power voltage provided by the power voltage.

3. A solid-state imaging device comprising:
unit cells arranged in rows and columns, each of said unit cells including: a photodiode which performs photoelectric conversion on incident light; a transfer transistor which transfers a signal charge generated in said photodiode; a floating diffusion which accumulates the signal charge transferred by said transfer transistor; a reset transistor which sets a potential of said floating diffusion to a reset potential; an amplifying transistor which outputs signal voltage depending on the potential of said floating diffusion; and a selecting transistor which outputs the signal voltage outputted from said amplifying transistor;
a column signal line which is provided for each of the rows of said unit cells, and transmits, in a column direction, the signal voltage outputted from said selecting transistor; and
a potential switching circuit connected to said column signal line and configured to set the potential of said floating diffusion to a potential lower than the reset potential via coupling of parasitic capacitance between a source and a gate of said amplification transistor by setting potential of said column signal line.

4. The solid-state imaging device according to claim 3 further comprising
a driving circuit connected to a gate of said reset transistor and a gate of said transfer transistor,
wherein said driving circuit is configured to set one of gate potentials of said transfer transistor and said reset transistor to a negative potential in a period of time other than a period of time when a signal charge is transferred from said photodiode to said floating diffusion.

5. The solid-state imaging device according to claim 4,
wherein said potential switching circuit is configured to set the potential of said floating diffusion to a potential lower than the reset potential after signal voltage is outputted from said unit cell or after a shutter operation is performed.

6. The solid-state imaging device according to claim 1,
a driving circuit connected to a gate of said reset transistor and a gate of said transfer transistor,
wherein said driving circuit is configured to set one of gate potentials of said transfer transistor and said reset transistor to a negative potential in a period of time other than a period of time when a signal charge is transferred from said photodiode to said floating diffusion.

7. The solid-state imaging device according to claim 1,
wherein said potential switching circuit is configured to set the potential of said floating diffusion to a potential lower than the reset potential after signal voltage is outputted from said unit cell or after a shutter operation is performed.
